(19) United States
(12) Patent Application Publication
(10) Pub. No.: US 2003/0103516 A1
(43) Pub. Date: Jun. 5, 2003

(54) Semiconductor lasers, and optical modules and systems using these lasers

(75) Inventors: Takeshi Kitatani, Hachioji (JP); Masahiko Kondow, Kodaira (JP); Makoto Kudo, Hamura (JP); Shinichi Nakatsuka, Hino (JP); Masahiro Aoki, Kokubunji (JP)

Correspondence Address: Mitchell W. Shapiro, Miles & Stockbridge P.C., Suite 500, 1751 Pinnacle Drive, McLean, VA, 22102-3833, US

(73) Assignee: Hitachi, Ltd.

(21) Appl. No.: 10/188,000

(22) Filed: Jul. 3, 2002

(30) Foreign Application Priority Data
Dec. 3, 2001 (JP) 2001-368182

(51) Int. Cl. H04L 12/28

(52) U.S. Cl. 370/419

(57) ABSTRACT

In a surface-emitting laser comprising an active region for emitting light and upper and lower DBR's sandwiching this active region from below and above to form resonators, a plurality of selective oxidation layers having an aperture which is an unoxidized region are formed in the upper DBR, lower DBR or both of them and the aperture is made wider stepwise as it becomes farther from the active region, thereby greatly reducing the capacitance of the laser. A high-speed optical module comprising the above surface-emitting laser as a light source has high performance, long service life and is inexpensive.

### BACKGROUND OF THE INVENTION

1. Field of the Invention

The present invention relates to semiconductor lasers, and optical modules and systems comprising the same.

2. Description of the Related Art

Owing to the recent explosion of the Internet population, high-speed information transmission is now sought for in local area networks (LAN) for offices and the like. It is assumed that a transmission rate in the order of Gb/s will be required for terminal users and a transmission rate of 50 Gb/s or more will be required for the backbone for linking HUB's in 2005.Five years after that, a transmission rate of more than 10 Gb/s will be needed even for terminal users. To this end, the total introduction of optical communication using optical fibers even to terminal users will be considered as essential in the near future. In general, optical modules comprising a semiconductor laser, photodiode and driving circuits thereof are used for optical communication. An optical module for use in future LAN must satisfy the performance requirement that high-speed transmission should be possible and must be provided at a low cost, in consideration of the fact that a huge number of general users will use it.

FIG. 1 is a schematic diagram of a prior art high-speed optical module having a transmission rate of more than 10 Gb/s. In the figure, 101 denotes a semiconductor laser, 102 a driving circuit of the semiconductor laser, 103 a modulator, 104 a thermoelectronic cooler, 105 a photodiode, 106 a driving circuit of the photodiode, 107 an optical module, 108 a driving circuit of the optical module, and 109 an optical fiber. The optical module emits a laser beam from the semiconductor laser 101 according to the driving circuit 108. A more than 10 Gb/s high-speed modulated beam is transmitted from the modulator 103. An optical signal transmitted from the optical module of the other party is received by the photodiode 105. All the optical signals are communicated at a high speed over the optical fibers 109. As the semiconductor laser is mainly used an end surface-emitting laser comprising an active region made from gallium indium phosphorus arsenide (GaInPAs)-based semiconductor material formed on an indium phosphorus (InP) substrate. Its oscillation wavelength is 1.3 μm or 1.55 μm so that it can be used with a single mode fiber which enables long-range high-speed transmission. In general, a GaInPAs-based laser has a disadvantage that when the temperature of the laser is raised, the threshold current greatly increases. Therefore, the thermoelectronic cooler 104 must be incorporated. In this constitution, the number of parts constituting an optical module is large, the resulting module is thereby large in size, and the cost of the optical module itself is high. This is greatly connected with the fact that a transmission rate of 10 Gb/s is used in a trunk network whose performance is considered more important than its cost. From this point of view, a high-speed optical module having a conventional structure is substantially not suitable for use in future LAN which must be provided at a low cost. The dotted lines in the figure indicate a dividing line between the transmission side where the semiconductor laser is installed and the receiving side where the photodiode is installed. These sides may be independently constructed as an optical transmission module and an optical receiving module. In the figure, a photodiode for an optical output monitor is omitted.

In contrast to this, a surface-emitting laser is attracting attention as a light source suitable for use in a high-speed optical module for future LAN. The surface-emitting laser has a resonator length of only several micrometers which is much shorter than the resonator length (several hundreds of micrometers) of an end surface-emitting laser and is basically excellent in high-speed characteristics. Further, it has other excellent features: (1) its beam is almost circular, (2) it can be easily connected to an optical fiber, (3) the step of cleavage is not required, (4) the inspection of elements per wafer is possible, (5) it can be oscillated with a low threshold current and (6) its power consumption is low, thereby making it possible to reduce costs.

FIG. 2 is a structural diagram of a general surface-emitting laser which is now implemented. In the figure, reference numeral 201 denotes a lower contact, 202 a semiconductor substrate, 203 a lower DBR (Distributed Bragg Reflector), 204 an active region, 205 an insulating part of a current confinement layer, 206 an aperture of the current confinement layer, 207 an upper DBR, 208 a contact layer, 209 an upper contact, 210 an upper barrier layer in the active region, 211 quantum wells in the active region and 212 a lower barrier layer in the active region.

As for the basic constitution of the surface-emitting laser, the surface-emitting laser is composed of the active region 204 for emitting light and an optical resonator consisting of the aperture 206 in the current confinement layer for injecting a current into the very small area of the active region, the upper DBR 207 and the lower DBR 203 disposed to sandwich the active region from above and below. The upper contact 209 and the lower contact 201 are formed to inject a current into the active region, and the contact layer 208 doped in a high concentration is formed on the upper contact side for good electrical contact. The active region generally consists of the quantum wells 211, the upper barrier layer 210 which has a larger forbidden bandwidth than the quantum wells 211 and the lower barrier layer 212, and the total thickness of the active region is determined by optical design. Therefore, the length of the optical resonator of the surface-emitting laser is several micrometers which is as small as the thickness of the active region. Meanwhile, as the reflectance's of the upper and lower DBR's must be set to an extremely large value (99.5% or more) to oscillate the laser, each of the DBR's is formed by piling up two different semiconductors having different refractive indices alternately at intervals of 1/4 the wavelength (λ/4 n: λ is wavelength and n is the refractive index of a semiconductive material). It is desired that the difference in refractive index between the two different semiconductor materials be as large as possible to obtain a high reflectance with a small number of layers to be laminated together. It is preferred that when the materials are semiconductor crystals, they agree with a substrate material in lattice to suppress dislocation caused by the disagreement of lattice. From these points of view, a DBR made from a GaAs/AlAs-based semiconductor material formed on a GaAs substrate is mainly used. The aperture 206 in the current confinement layer is essential to the reduction of the threshold value of current for the laser and single mode, is disposed at a desired position between the active region and the contacts for injecting a current and serves to confine the current to be injected into the active region to a very small area as large as several micrometers to several tens of micrometers (to be referred to as “aperture” hereinafter). Stated more specifically, a method in which an Al(Ga)As layer introduced into the structure of the laser is selectively oxidized from the transverse direction to convert it into aluminum oxide (AlxOy) as an insulating part 205 in the current confinement layer in order to confine a current to the very small Al(Ga)As area left at the center is mainly used these days.

Meanwhile, since a prior art surface-emitting laser has a large capacitance, a surface-emitting laser having a different structure is now under investigation. Examples of such surface-emitting laser are disclosed in Japanese Patent Publication No. 11-4040 and Japanese Patent Publication No. 2000-261094.FIG. 3 shows a structural diagram of the laser. In the figure, reference numeral 301 denotes a lower contact, 302 a semiconductor substrate, 303 a lower DBR, 304 an active region, 305 an insulating part of a current confinement layer, 306 an aperture of the current confinement layer, 307 an insulating part of a capacitance reducing layer, 308 an aperture of the capacitance reducing layer, 309 an upper DBR, 310 a contact layer, 311 an upper contact, 312 an upper barrier layer in the active region, 313 quantum wells in the active region, and 314 a lower barrier layer in the active region. In this structure, the capacitance reducing layer 307 and 308 having an aperture wider than the aperture 305 in the current confinement layer is formed between the current confinement layer 305 and 306 and the upper DBR 309 to increase the thickness of the insulating part so as to reduce capacitance. To form the capacitance reducing layer 307 and 308, a technique for selectively oxidizing AlAs like the current confinement layer 305 and 306 is employed. In fact, several capacitance reducing layers having one aperture which differs from the aperture of the current confinement layer are formed adjacent to the current confinement layer.

### SUMMARY OF THE INVENTION

It is an object of the present invention to provide a surface-emitting laser capable of high-speed operation. The present invention is aimed to achieve an operation speed of 10 Gb/s or more, for example, 50 Gb/s.

It is another object of the present invention to provide a surface-emitting laser which is capable of high-speed operation and inexpensive.

It is still another object of the present invention to provide an optical module comprising a surface-emitting laser capable of high-speed operation.

To attain the above objects, the following problems of a surface-emitting laser must be solved technically. That is, a new surface-emitting laser structure is employed to reduce C in the product (CR product) of the capacitance (C) and resistance (R) of a laser indispensable for high-speed operation. To this end, a new technique for increasing the thickness of an insulating part in the laser must be provided. Meanwhile, this narrows the path for injecting a current and increases R. That is, C and R have a trade-off relationship. Therefore, it is necessary to achieve a great reduction in the CR product by reducing C and suitably controlling an increase in R.

According to a first aspect of the present invention, there is provided a surface-emitting laser which comprises an active region, first and second DBR's sandwiching this active region from above and below with surfaces parallel to the main surface of the active region to form optical resonators, a first contact formed on at least one of the first and second DBR's and a second contact on the opposite side to the first contact with the above resonators interposed therebetween on a semiconductor substrate; and which has a plurality of layers forming a first lamellar region having an insulating region in its peripheral portion on a surface parallel to the main surface of the active region and close to the active region and a second lamellar region having an insulating region in its peripheral portion on a surface farther from the active region than the first lamellar region in the inside of at least one of the first and second DBR's, the width of the insulating region in the peripheral portion of the second lamellar region of the plurality of layers being smaller than the width of the insulating region in the peripheral portion of the first lamellar region.

According to a second aspect of the present invention, there is provided a surface-emitting laser, wherein the DBR is a multi-layer DBR's having semiconductor layers and the insulating regions in the peripheral portions of the first and second lamellar regions existent in the inside of the DBR are formed by selectively oxidizing the semiconductor layers of the multi-layer DBR.

According to a third aspect of the present invention, there is provided a surface-emitting laser, wherein the insulating regions in the peripheral portions of the first and second lamellar regions existent in the inside of the DBR are formed by selectively oxidizing the semiconductor layers of the multi-layer DBR and the width of the insulating region in the peripheral portion of the second lamellar region decreases as it becomes farther from the active region.

According to a fourth aspect of the present invention, there is provided a surface-emitting surface comprising an active region for emitting light and upper and lower DBR's sandwiching the active region from above and below to form resonators on a semiconductor substrate, wherein a plurality of selective oxidation layers having an aperture which is an unoxidized region are formed in an upper DBR, lower DBR or both of them, and the aperture becomes wider stepwise as it becomes farther from the active region. It is particularly desired that the upper selective oxidation layers be formed from the active region close to or up to the end on the opposite side to the active region. The size of the aperture may be changed linearly or curved. Actual embodiments of the present invention are described in the Detailed Description of the Preferred Embodiments. It is preferred that at least one semiconductor film containing 90% or more of Al as a group III atom be used to form the above selective oxidation layers.

In the above description, only a surface-emitting laser was explained. The same inventive idea can be applied to an end surface-emitting laser. In this case, the invented idea of the DBR may be applied to so-called cladding layers sandwiching the active region from above and below. The above lamellar insulating region may be formed in at least one of the upper and lower cladding layers in the same configuration. It is also effective to use the above selective oxidation layers in the lamellar insulating region.

Other and further objects, features and advantages of the invention will appear more fully from the following description.

### BRIEF DESCRIPTION OF THE DRAWINGS

FIG. 1 is a structural diagram of a high-speed optical module of the prior art;

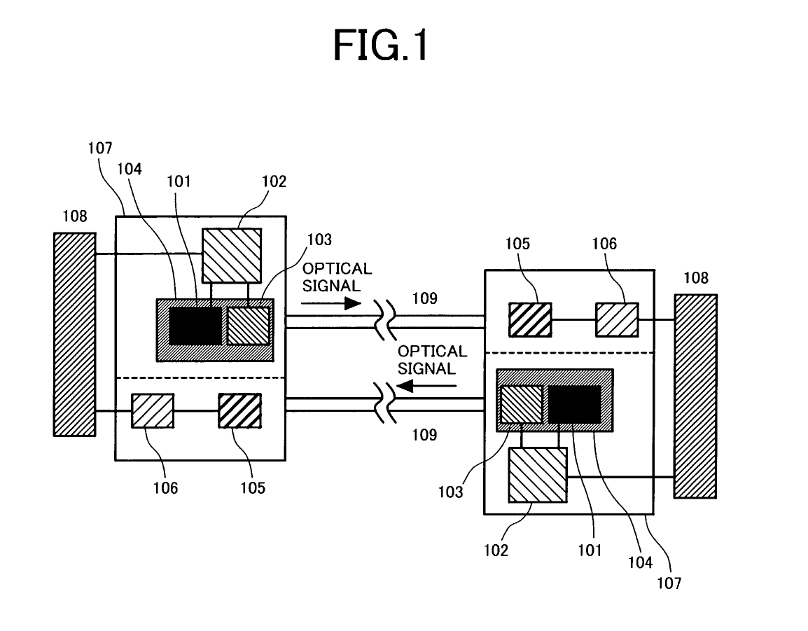

FIG. 2 is a structural diagram of a surface-emitting laser of the prior art;

FIG. 3 is a structural diagram of a surface-emitting laser of the prior art which is aimed to reduce the capacitance of the laser;

FIG. 4 is a diagram showing changes in CR time constant and f3 dB in the laser of the prior art;

FIG. 5 is a structural diagram of a surface-emitting laser of the present invention;

FIG. 6 is a diagram showing changes in CR time constant and f3 dB of the laser of the present invention;

FIG. 7 is a diagram showing changes in C and R in the lasers of the present invention and the prior art;

FIG. 8 is a diagram showing Example 1 of the present invention;

FIG. 9 is a diagram showing Example 2 of the present invention;

FIG. 10 is a perspective view of an optical module of the present invention;

FIG. 11 is a structural diagram of an optical module of the present invention;

FIG. 12 is a diagram showing that the laser of the present invention is mounted to an optical module;

FIG. 13 is a diagram showing the relationship between the content of Ga in an AlGaAs film and oxidation speed; and

FIG. 14 is a structural diagram of an end surface-emitting laser of the present invention.

### DETAILED DESCRIPTION OF THE PREFERRED EMBODIMENTS

Before describing a preferred embodiment of the present invention, the basic idea of the present invention will be described in detail.

In order to realize a high-speed optical module for use in future LAN, a semiconductor laser used as a light source for the optical module must achieve high-speed characteristics. To this end, C and R of a semiconductor laser must be reduced.

In general, the basic high-speed modulation characteristics of a semiconductor laser are evaluated by modulation frequency (f3 dB) by which the optical output of the laser is reduced by 3 dB. F3 dB is expressed by the following equation (1) using C and R.

f3 dB=1/(2πCR) (1)

This fact is described, for example, at page 184 of “Up-to-date Optoelectronics Series: Basis and Application of Surface-emitting Laser” written by Kenichi Iga and Fumio Koyama and published by Kyoritsu Shuppan Co., Ltd.

It is understood from the above equation (1) that to achieve 50 Gb/s as f3 dB of the laser, the CR product must be about 3 e⁻¹²FΩ.

The present invention is to provide a novel structure for realizing a semiconductor laser device having the above characteristics as will be detailed hereinafter.

<Typical Embodiment of the Present Invention>

An embodiment of the present invention which eliminates disadvantages which are seen in the prior art will be described in detail.

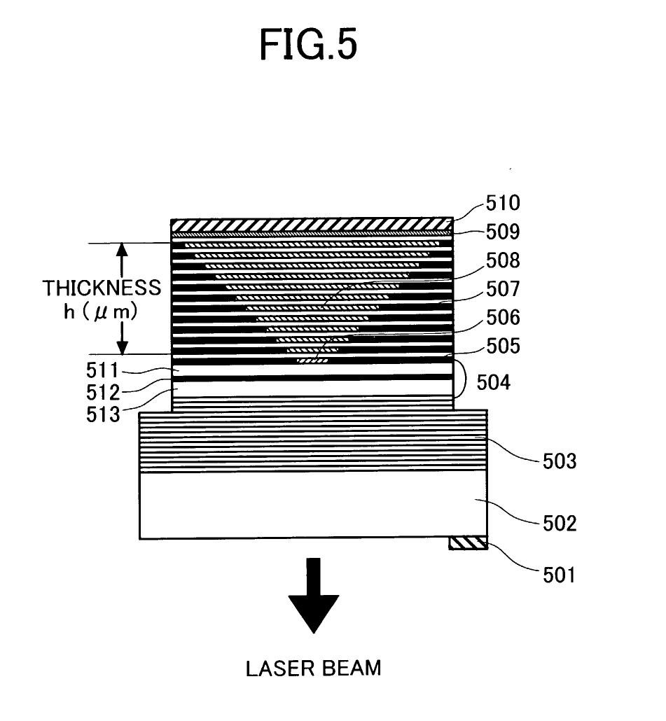

FIG. 5 is a sectional view of the structure of the laser of the present invention.

In FIG. 5, 501 denotes a lower contact, 502 a semiconductor substrate, 503 a lower DBR, 504 an active region, 505 an insulating part of a current confinement layer, 506 an aperture of the current confinement layer, 507 an insulating part of a selective oxidation layer, 508 an aperture of the selective oxidation layer, 509 a contact layer, 510 an upper contact, 511 an upper barrier layer in the active region, 512 quantum wells in the active region, and 513 a lower barrier layer in the active region. In this structure, the selective oxidation layers 507 and 508 having an aperture which becomes wider stepwise as it becomes farther from the active region are formed on the current confinement layer 505 and 506 to reduce C and suppress an increase in R so as to reduce the CR product. The method of forming the selective oxidation layers 507 and 508 is the same as the current confinement layer 505 and 506. The aperture 508 in the selective oxidation layers is changed linearly from the outer ends of the aperture in the current confinement layer toward the outer ends of the mesa of the contact layer 509. As for other members of the semiconductor laser, such as the lamellar insulating region, typically the active region other than the region including the selective oxidation layers, a conventional technology may suffice.

In the laser of the present invention, the aperture in the selective oxidation layers becomes wider stepwise as it becomes farther from the current confinement layer and the active region.

As well known, C and R are expressed by the following equations.

C=ε·S1/d (2)

R=ρ·l/S2 (3)

wherein ε is a dielectric constant, S1 is the area of the insulating part, d is the thickness of the insulating part, ρ is resistivity (including the influence of hetero junction), l is the thickness of the conductive part and S2 is the area of the conductive part.

As shown by the equation (2), C is in proportion to the area S1 of the insulating part and inverse proportion to the thickness d of the insulating part. In this structure, a part where d for increasing C the most is small is only the region near the current confinement layer and the thickness of the insulating part is gradually increased to reduce C in other regions in order to reduce C of the whole device. Meanwhile, as shown in the equation (3), R is in inverse proportion to the area S2 of the conductive part and proportion to the thickness l of the conductive part. Since the area of a carrier conducting path from the upper contact 510 to the conductive parts 508 of the selective oxidation layers, the conductive part 506 of the current confinement layer and the active region 504 is narrowed gradually, there is no chance of sharply increasing R.

Further, voltage is applied between upper and lower contacts during the operation of the laser to generate an electric field between the upper contact 510 and the aperture 506 of the current confinement layer. Most of the carriers injected transmit in a region formed by linearly connecting the outer ends of the upper contact to the outer ends of the conductive part of the current confinement layer according to this electric field with a certain expanse. Therefore, a region other than this conductive region becomes an invalid region not contributed to the transmission of the carriers. In the present invention, it can be said that an invalid region not contributed to the transmission of carriers is insulated by selective oxidation and used effectively as a capacitance reducing layer.

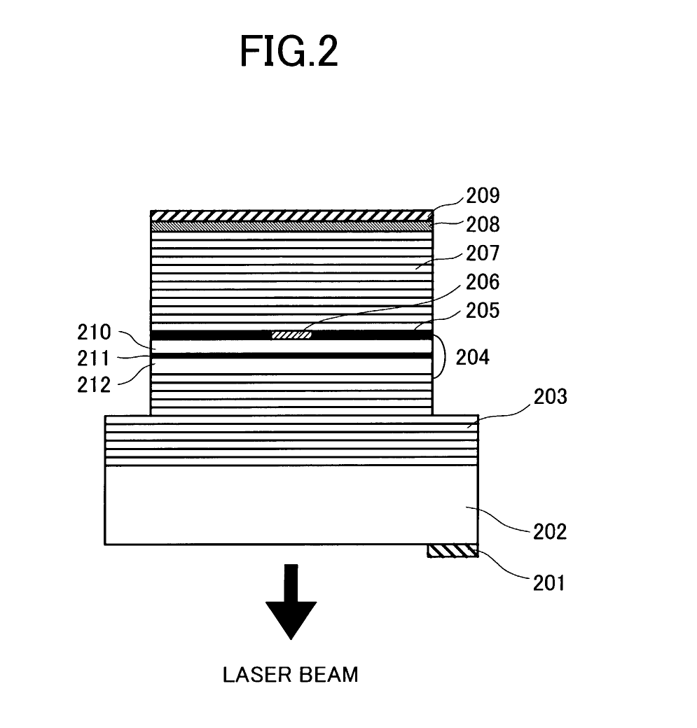

To verify the effect of the present invention, as shown in FIG. 5, changes in the CR product and f3 dB of the laser when the total thickness of the selective oxidation layers is represented by h based on the current confinement layer were obtained. In this instance, the mesa of a surface-emitting laser was circular, its diameter was 20 μm, and the diameter of the current confinement layer was 5 μm. The thickness of the upper p type DBR was 5 μm and the thickness of the active region was 0.5 μm. The obtained values are shown as relative values when the value of a general surface-emitting laser structure as shown in FIG. 2 is 1.

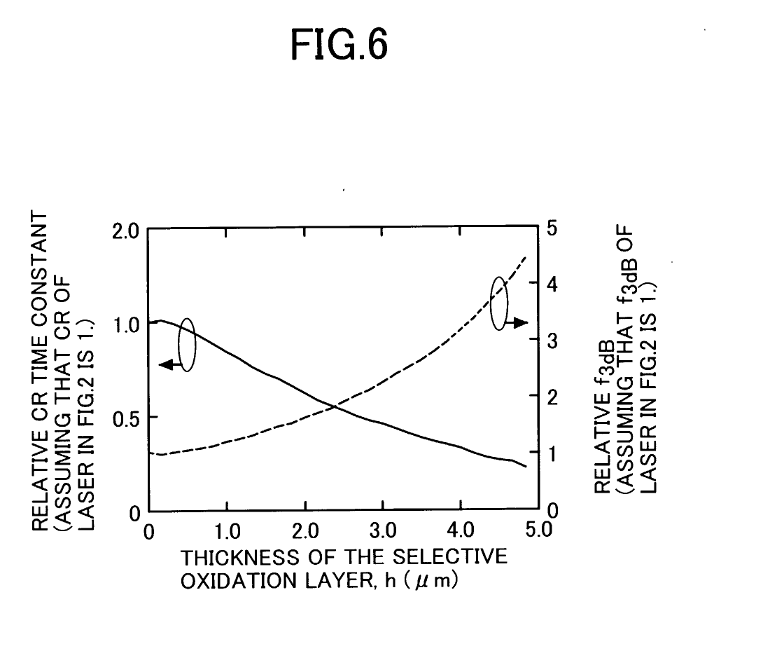

FIG. 6 shows the results. It is understood that by increasing h, the CR product can be reduced and f3 dB can be improved at the same time. It was found that f3 dB can be improved to about 2 times by introducing selective oxidation layers having a total thickness h of 2.5 μm. It was made clear that the CR product can be further reduced by increasing h and f3 dB can be improved to 4 times or more that of the laser shown in FIG. 2 when the total thickness of the selective oxidation layers introduced up to the upper end of the upper DBR is 5 μm. Therefore, to obtain the effect of the structure of the present invention sufficiently, it is more desired that the selective oxidation layers be formed close to or up to the end of the upper DBR.

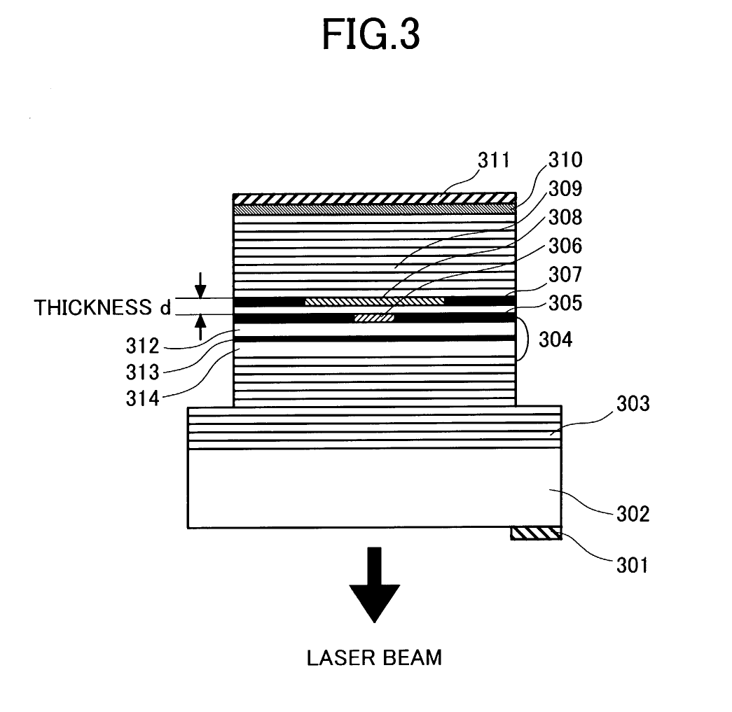

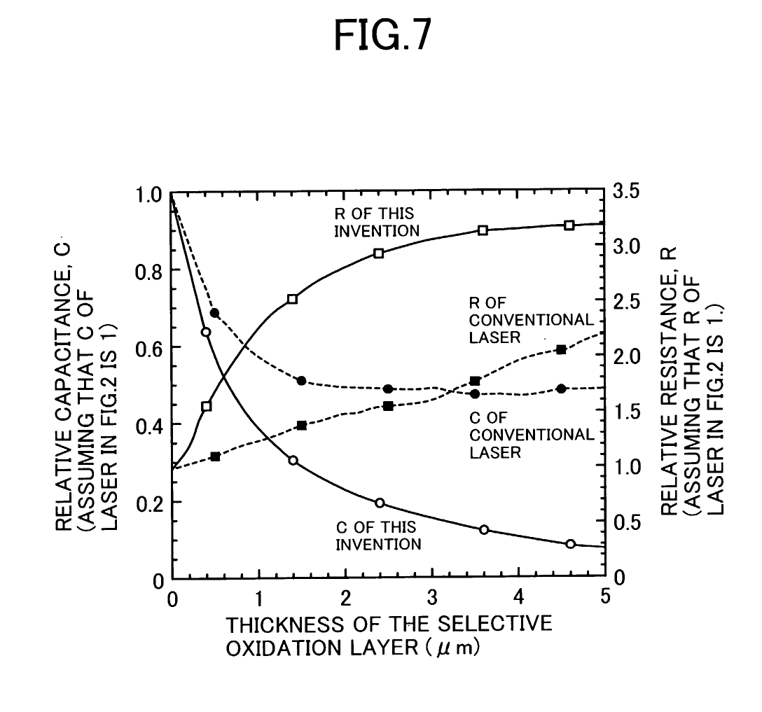

FIG. 7 shows changes in C and R of the structure of the present invention. To make clear the effect of the present invention by comparison with the prior art, changes in C and R of the prior art laser of FIG. 3 are also shown in the figure. It is understood that C can be reduced only by about 50% when the thickness is approximately an optimal value of 1.5 μm in the prior art laser whereas C can be reduced to 1/10 or less when the thickness is about 5 μm in the laser of this structure. Meanwhile, R of the present invention is increased to about 3 times according to the trade-off relationship of CR as described previously. However, there will be no problem with the driving circuit of the laser when R is around this value.

Further, the insulating part 507 in the selective oxidation layer of the present invention is formed by subjecting Al(Ga)As to the selective oxidation step and eliminating As to form AlxOy. The refractive index of AlxOy is about 1.5 and greatly differs from that (refractive index of 3.4) of GaAs and that (refractive index of 2.9) of Al(Ga)As for forming the aperture 508 in the selective oxidation layers. The emitted laser beam goes back and forth in the aperture 508 in the selective oxidation layers with a certain expanse. This great difference of refractive index confines the expanse of the laser beam in a horizontal direction effectively, thereby improving the characteristics of the laser. Since the aperture 508 in the selective oxidation layers becomes wider gradually in the present invention, a loss caused by the scattering of the laser beam transmitting with a certain expanse as described above at an interface between the insulating parts 507 and the aperture 508 in the selective oxidation layers can also be suppressed.

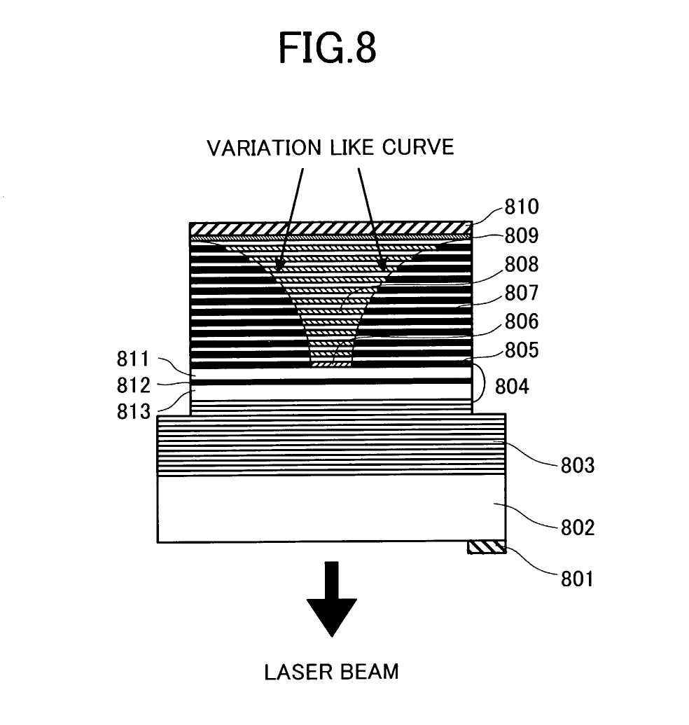

FIG. 8 shows another example of the structure of the present invention. In FIG. 8, reference numeral 801 denotes a lower contact, 802 a semiconductor substrate, 803 a lower DBR, 804 an active region, 805 an insulating part of a current confinement layer, 806 an aperture of the current confinement layer, 807 an insulating part of a selective oxidation layer, 808 an aperture of the selective oxidation layer, 809 a contact layer, 810 an upper contact, 811 an upper barrier layer in the active region, 812 quantum wells in the active region, and 813 a lower barrier layer in the active region. In this structure, the aperture 808 in the selective oxidation layers is curved from the outer ends of the aperture of the current confinement layer toward the outer ends of the mesa of the contact layer 509. In this structure, the area of the insulating part in the selective oxidation layers can be made larger than in the structure of FIG. 5, thereby making it possible to further reduce capacitance.

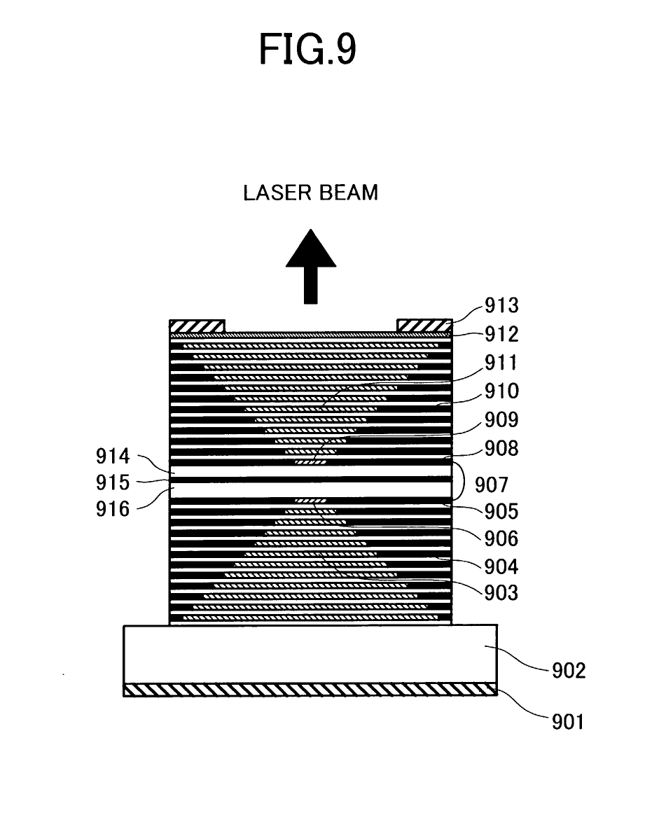

FIG. 9 shows another example of this structure. In FIG. 9, reference numeral 901 represents a lower contact, 902 a semiconductor substrate, 903 an insulating part of a lower selective oxidation layer, 904 an aperture of the lower selective oxidation layer, 905 an insulating part of a lower current confinement layer, 906 an aperture of the lower current confinement layer, 907 an active region, 908 an insulating part of an upper current confinement layer, 909 an aperture of the upper current confinement layer, 910 an insulating part of an upper selective oxidation layer, 911 an aperture of the upper selective oxidation layer, 912 a contact layer, 913 an upper contact, 914 an upper barrier layer in the active region, 915 quantum wells in the active region, and 916 a lower barrier layer in the active region. In this structure, the selective oxidation layers whose aperture becomes wider stepwise are disposed vertically above and below the active region. Owing to this structure, the thicknesses of the insulating parts can be increased and capacitance can be further reduced.

According to the above effect, using the structure of the present invention, the characteristics of the surface-emitting laser can be greatly improved compared with the laser of the prior art and a targeted speed higher than 50 Gb/s can be achieved.

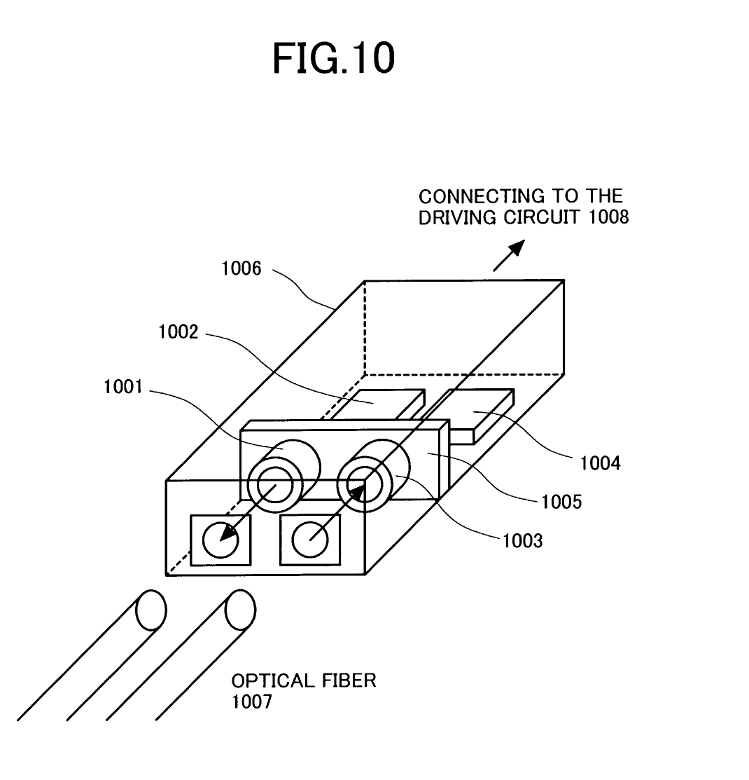

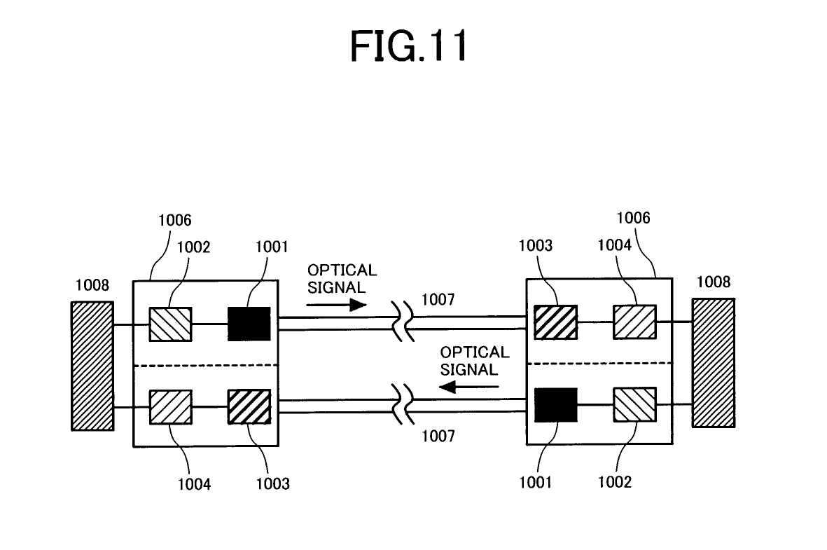

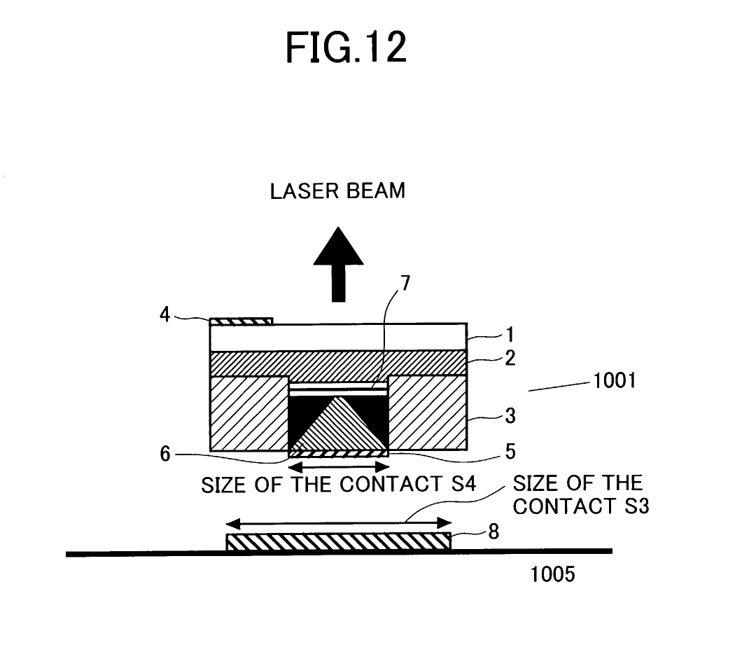

A description is subsequently given of an optical module comprising the laser of the present invention. FIG. 10 is a perspective view of the optical module. FIG. 11 is a schematic diagram of an optical transmission module comprising the surface-emitting laser of the present invention. In these figures, reference numeral 1001 denotes the vertical-cavity surface-emitting laser of the present invention, 1002 a driving circuit of the semiconductor laser, 1003 a photodiode, 1004 a driving circuit of the photodiode, 1005 a rack for fixing the laser and photodiode, 1006 an optical module, 1007 an optical fiber, and 1008 a driving circuit of the optical module. FIG. 12 is a schematic diagram showing that the vertical-cavity surface-emitting laser 1001 of the present invention is fixed to the rack 1005 for fixing the laser and photodiode. A contact is formed on the rack 1005 for electrical connection to the driving circuit and the like. A mounting system so called “junction down” that the substrate is faced up when the laser is to be mounted is preferred because heat radiation from the active region is large during the operation of the laser. At this point, the surface-emitting laser must have a structure that a laser beam is emitted from the back. The upper contact of the laser and the contact of the rack are connected to each other by soldering. Since they are not directly viewed, it is difficult to align these parts. Therefore, the contact area S3 of the rack is made larger than the area S4 of the upper contact of the laser (S3>S4). A portion other than a contacting portion with the upper contact of the laser of the contact of the rack adds new capacitance between the contact and the laser, thereby causing an increase in the capacitance of the optical module itself. Then, in the optical module of the prior art which comprises a surface-emitting laser having a large capacitance as a light source, S3 must be minimized to avoid this. Meanwhile, minimizing S3 causes a reduction in yield in the alignment step for junction-down mounting.

Meanwhile, as the surface-emitting laser of the present invention has an extremely low capacitance, S3 may be made larger than that of the prior art module. This effect makes easy alignment for junction-down mounting, thereby making it possible to greatly improve yield in this step. As described above, the junction-down mounting is excellent in the heat radiation characteristics of the laser. Therefore, the temperature variations of the laser are small. In addition, the threshold current value of the surface-emitting laser itself is small, whereby variations in the threshold current value at the time of use are extremely small. Consequently, the laser can be driven by a small-sized and simple circuit. As already shown in FIG. 10 and FIG. 11, the optical module does not need a thermoelectronic cooler and an APC circuit which have been required in the prior art. Thereby, the number of parts can be greatly reduced and the size of the driving circuit can be reduced. As a result, the optical module itself becomes small in size, thereby making possible a great cost reduction. A high production yield of the optical module is effective in reducing costs as well. Further, since this optical module is excellent in the heat radiation characteristics of the surface-emitting laser, the active region hardly deteriorates, thereby making it possible to provide stable characteristics for a longer time than the optical module of the prior art. The above effects become more marked in a surface-emitting laser using an active region material having excellent temperature characteristics and capable of confining electrons in the deep potential wells of the active region, for example, GaInNAs as described above.

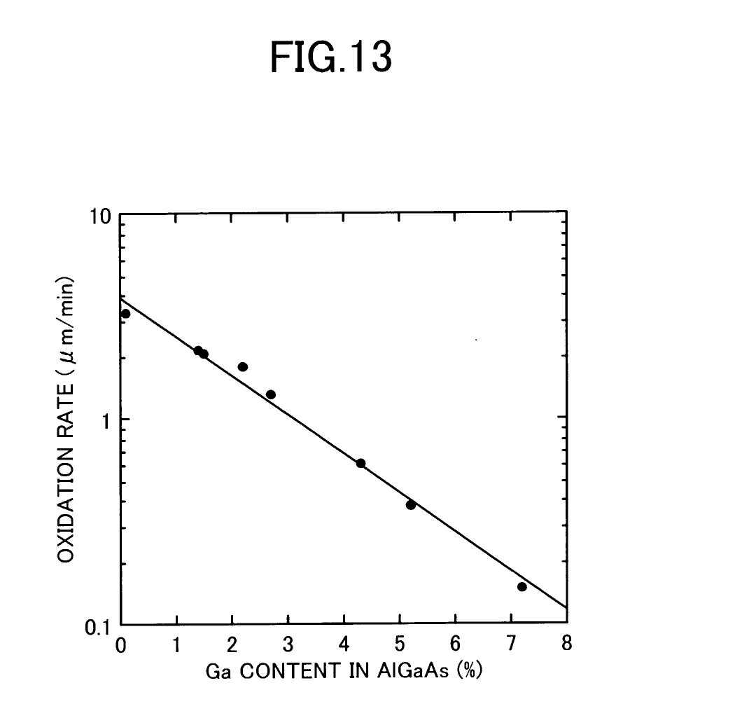

A description is subsequently given of the process for manufacturing the structure of the present invention. In the present invention, the aperture in the selective oxidation layers must be made wider stepwise with accuracy. As described previously, AlGaAs is generally used in the current confinement layer. FIG. 13 shows the relationship between the content of Ga in AlGaAs and oxidation rate. It is understood that as the content of Ga increases, the oxidation rate greatly lowers. Therefore, when crystals are grown by gradually increasing the Ga content of AlGaAs used in the DBR from the current confinement layer as it becomes farther from the active region, the obtained multi-layer wafer is etched in a mesa form, and one time of the oxidation step is carried out like the prior art laser, the structure of the present invention can be easily obtained. Since other process steps may be the same as those of the prior art laser, the number of the steps required for the manufacture of the structure of the present invention is not increased and the production cost is thereby not boosted.

It is understood from FIG. 13 that when the content of Ga in the AlGaAs layer used as the selective oxidation layers is 10% or less, that is, the content of Al is 90% or more, the structure of the present invention can be manufactured very accurately. Even when a group III-V compound semiconductor material other than AlGaAs is used, if the content of Al is 90% or more, similar selective oxidation conditions are obtained. Thereby, the structure of the present invention can be manufactured. Giving examples of the group III-V group semiconductor material, it is a mixed liquid semiconductor selected from combinations of a group III atom such as Al, Ga or In and a group V atom such as As, P, Sb or N.

An example in which an aperture is formed in the upper DBR using the ion injection or diffusion of oxygen is disclosed in Japanese Patent Publication No. 11-112086. However, the precision control of the aperture as in the present invention is difficult with this technology and reproducibility is low. As still remains in the Al(Ga)As film insulated by ion injection or diffusion and the material of the above publication is completely different from that of the present invention in which AlxOy is formed by a selective oxidation method. Further, the refractive index of insulated AlGaAs containing the residual As is around 3 and there is no great difference in refractive index between GaAs (refractive index of 3.6) for forming the aperture in the selective oxidation layers and Al(Ga)As. Therefore, the confinement of light becomes unsatisfactory and the characteristics of the laser greatly deteriorate compared with the present invention.

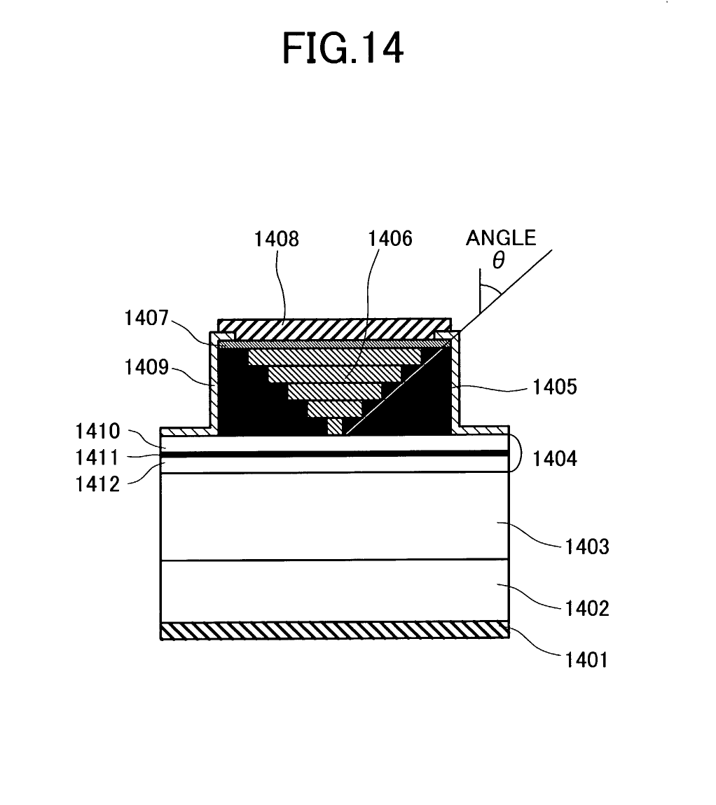

The present invention can be applied to an end surface-emitting laser. FIG. 14 shows an example of the laser.

In FIG. 14, reference numeral 1401 denotes a lower contact, 1402 a semiconductor substrate, 1403 a lower cladding layer, 1404 an active region, 1405 an insulating part of selective oxidation layers in an upper cladding layer, 1406 an aperture of the selective oxidation layers in the upper cladding layer, 1407 a contact layer, 1408 an upper contact, 1409 SiO₂, 1410 an upper barrier layer in the active region, 1411 quantum wells in the active region, and 1412 a lower barrier layer in the active region. In the present structure, the selective oxidation layers 1405 and 1406 having an aperture which becomes wider stepwise as it becomes farther from the active region are formed in the upper cladding layer. The aperture 1406 in the selective oxidation layers is changed linearly from the outer ends of the aperture of the current confinement layer toward the outer ends of the mesa of the contact layer 1407. When the angle of the aperture with respect to the direction perpendicular to the substrate is represented by θ, as θ increases, the contact area becomes larger, thereby making it possible to reduce the contact resistance of the laser. Further, heat radiation characteristics can be thereby improved. In the prior art method of forming an inverted mesa type laser using wet etching, the limit of θ is around 45°. In contrast to this, in the present invention, θ can be increased to more than 45° by design and the production yield improves due to high controllability. Therefore, even when the structure of the present invention is applied to an end surface-emitting laser, it is effective in improving the characteristics of the laser.

An increase in the resistance of the laser caused by a hetero interface is suppressed as much as possible by laminating together five of the selective oxidation layers 1405 and 1406.

<Embodiment 1 of the Present Invention>

A detailed description is given of the manufacture of a surface-emitting laser structure capable of reducing the capacitance of the laser of the present invention as Embodiment 1 of the present invention. The structure of the laser is already shown in FIG. 5. In the manufacture of the surface-emitting laser structure, a molecular beam epitaxy (MBE) method, organic metal chemical vapor deposition (MOCVD) method, chemical beam epitaxy (CBE) method and the like all of which enables instantaneous change of materials are suitable due to the need for the formation of a steep hetero interface and the precision control of film thickness. When GaInNAs is used in the active region, a deposition method in an imbalance state is advantages in the introduction of N. In this sense, the above MBE method, MOCVD method and CBE method are suitable as a deposition method. Since the effect of the present invention can be obtained if a similar structure can be formed, the present invention is not limited only to the above deposition methods. In this embodiment, a solid source MBE (SS-MBE) method was used as the deposition method. In the SS-MBE method, gallium (Ga) or indium (In) was used as a group III element source and metal As (arsenide) was used as a group V element source. Silicon (Si) was used as an n type impurity and carbon tetrabromide (CBr₄) was used as an impurity raw material which can be doped as a p type impurity in a high concentration. Beryllium (Be) or zinc (Zn) may be used as a p type impurity if the same doping concentration can be attained. As for nitrogen (N), N radicals obtained by exciting N₂ gas with RF plasma were used. The excitation of nitrogen plasma may be carried out by using ECR (Electron Cycrotron Resonance) plasma.

An n type GaAs (100) substrate 502 (n type doping concentration=2×10¹⁸ cm⁻³) was used as a semiconductor substrate. After the substrate was heated in an As atmosphere, n type Al_{0.9} Ga_{0.1} As/GaAs (n type impurity concentration=1×10¹⁸ cm⁻³) was deposited 30 times on the substrate to form a lower DBR 503. The thickness of the DBR was set to 1/4 the wavelength in the semiconductor. Thereafter, a non-doped GaAs lower barrier layer 513 having a thickness 1/2 the wavelength, a quantum well layer 512 having a triple (double??) quantum well structure consisting of 10 nm-thick non-doped Ga_{0.7}In_{0.3}Na_{0.01}As_{0.99} and 10 nm-thick non-doped GaAs barrier layers, a non-doped GaAs upper barrier layer 511 having a thickness 1/2 the wavelength, and p type AlGaAs current confinement layer 505 and 506 having a thickness 1/4 the wavelength (p type impurity concentration=1×10¹⁸ cm⁻³) were formed in the mentioned order. Thereafter, 24 selective oxidation layers 507 and 508 made from p type AlGaAs/GaAs (p type impurity concentration=1×10¹⁸ cm⁻³), which is the structure of the present invention, were deposited. The Ga content of AlGaAs of the current confinement layer and the 25 selective oxidation layers was changed every 0.3 μm of the oxidation distance from 7.5 μm to 0.3 μm as it becomes farther from the active region according to the conditions of FIG. 13. Since the uppermost GaAs layer was a p type contact layer 509, p type doping of 1×10¹⁹ cm⁻³ was carried out. The crystal growth step was thus completed. Subsequently, the process step of manufacturing a laser structure was made on the complete multi-layer grown wafer. SiO₂ was first deposited on the entire surface of the wafer and patterned in a circular form having a mesa diameter of 20 μm in a photolithographic (??) step, and mesa etching was carried out up to a portion right below the current confinement layer 505 and 506 using this patterned mask. A mixed solution of hydrogen bromide (HBr), hydrogen peroxide (H₂O₂) and water (H₂O) was used as an etchant. Selective oxidation was then made on the formed mesa structure for current confinement. In a steam atmosphere, the wafer was heated at 400° C. to change the side portions of the current confinement layer 505 and 506 and the selective oxidation layers 507 and 508 to AlxOy insulating layers. Thereby, the selective oxidation layers having an aperture which became wider stepwise as shown in FIG. 5 were formed. Thereafter, SiO₂ was removed and a photolithographic step was carried out to form a p-side upper contact 510 and an n-side lower contact 501 so as to complete a laser. The thus manufactured surface-emitting laser continuously oscillated at an oscillation wavelength of 1.3 μm and a threshold current of 0.1 mA at room temperature and had a capacitance of 30 fF. Thus, the laser showed excellent modulation characteristics.

Subsequently, an optical module shown in FIG. 10 and FIG. 11 was built using this laser. The optical module of the present invention had a small number of parts and was small in size due to a simple driving circuit of the laser. Particularly, use of GaInNAs having excellent temperature characteristics as the material of the active region contributed to the above effects. The production yield of the laser was high and the production cost could be greatly reduced. Further, since the capacitance of the surface-emitting laser was low and the laser was mounted to the optical module of the present invention by the junction-down system, the amount of heat generated was small and the deterioration of the active region hardly occurred. Therefore, stable characteristics could be provided for a longer time than the optical module of the prior art.

By selecting a desired value of the content of Ga in AlGaAs of the selective oxidation layers 507 and 508 according to the conditions of FIG. 13, a laser whose aperture was curved as shown in FIG. 8 could be manufactured.

<Embodiment 2 of the Present Invention>

The manufacture of a surface-emitting laser structure which can reduce capacitance of the present invention will be described in detail as Embodiment 2 of the present invention. The structure of the laser is already shown in FIG. 9.

The MOCVD method was used for the manufacture of the structure of the laser. Organic metal triethyl gallium (TEG) and trimethyl indium (TMI) were used as sources of Ga and In which are both group III elements, respectively, and AsH₃ was used as an As source which is a group V element. Silane (SiH₄) was used as an n type impurity and CBr₄ was used as a p type impurity. Dimethylhydrazine (DMHy) was used as an N source.

An n type GaAs (100) substrate 902 (n type impurity concentration=1×10¹⁸ cm⁻³) was used as a semiconductor substrate. After the substrate was heated in an As atmosphere while AsH₃ was supplied, n type AlGaAs/GaAs (n type impurity concentration=1×10¹⁸ cm⁻³) was deposited 25 times on the substrate to form lower selective oxidation layers 903 and 904. The thickness of each layer was set to 1/4 the wavelength in the semiconductor. Thereafter, an n type AlGaAs lower current confinement layer (n type impurity concentration=1×10¹⁸ cm⁻³) 905 and 906, a non-doped GaAs lower barrier layer 916 having a thickness 1/2 the wavelength, and a double quantum well active layer 915 consisting of a 10 nm-thick non-doped Ga_{0.7}In_{0.3}Na_{0.04}As_{0.96} quantum well layer and a 10 nm-thick non-doped GaAs layer were formed. Thereafter, a non-doped GaAs upper barrier layer 914 having a thickness 1/2 the wavelength and a p type AlGaAs upper current confinement layer (p type impurity concentration=1×10¹⁸ cm⁻³) 908 and 909 having a thickness 1/4 the wavelength were formed in the mentioned order. Further, upper selective oxidation layers 910 and 911 made from p type AlGaAs/GaAs (p type impurity concentration=1×10¹⁸ cm⁻³) were deposited. To form apertures which became wider stepwise in a vertical direction with the active region interposed therebetween as shown in FIG. 9, the Ga content of AlGaAs of the current confinement layer and the 25 selective oxidation layers above and below the active region was changed every 0.3 μm of the oxidation distance from 7.5 μm to 0.3 μm according to the conditions of FIG. 13. Since the uppermost GaAs layer above the upper selective oxidation layers was the p type contact layer 912, p type doping of 1×10¹⁹ cm⁻³ was carried out. The crystal growth step was thus completed. Subsequently, the process step for the manufacture of a laser structure was made on the complete multi-layer grown wafer. SiO₂ was first deposited on the entire surface of the wafer and patterned in a circular form having a diameter of 20 μm in a photolithographic step, and the lower selective oxidation layers 904 and 904 were removed by etching using this patterned mask. Selective oxidation was then made on the formed mesa structure for current confinement. In a steam atmosphere, the wafer was heated at 400° C. to change the side portions of the upper and lower current confinement layers and the selective oxidation layers to AlxOy insulating layers. Thereby, selective oxidation layers having apertures which became wider stepwise in a vertical direction with the active region interposed therebetween as shown in FIG. 9 were formed. Thereafter, SiO₂ was removed and a photolithographic step was carried out to form a ring-shaped p-side upper contact 913 and an n-side lower contact 901 so as to complete a laser. The thus manufactured surface-emitting laser continuously oscillated at an oscillation wavelength of 1.3 μm and a threshold current of 0.1 mA at room temperature and had a capacitance of 20 fF. Thus, the laser showed excellent modulation characteristics.

Subsequently, an optical module shown in FIG. 10 and FIG. 11 was built using this laser. Since this laser emitted light toward above, junction-down mounting was impossible. However, due to the capacitance reducing effect of the laser itself, a high-performance and low-cost module could be obtained.

In this embodiment, two surface-emitting lasers comprising a GaInNAs active region were described. The present invention is not limited to these. A surface-emitting laser which emits light having a wavelength of 1.3 μm can be manufactured using another material such as GaAsSb. A surface-emitting laser which emits light having a wavelength of 1 μm or less can be manufactured by using GaAs or GaInAs in the active region. Thereby, a high-performance and low-cost optical module can be provided.

<Embodiment 3 of the Present Invention>

The manufacture of an end surface-emitting laser of the present invention will be described in detail as Embodiment 3 of the present invention. The structure of the laser is as shown in FIG. 14.

The MOCVD method was used for the manufacture of the structure of this laser like Embodiment 2. The raw materials used are the same as in Embodiment 2. An n type GaAs (100) substrate 1402 (n type impurity concentration=1×10¹⁸ cm⁻³) was used as a semiconductor substrate. After the substrate was heated in an As atmosphere while AsH₃ was supplied, a lower cladding layer 1403 made from n type Al_{0.3}Ga_{0.7}As (n type impurity concentration=1×10¹⁸ cm⁻³) was formed on the substrate. A non-doped GaAs lower barrier layer 1412 and a double quantum well active layer 1411 consisting of a 10 nm-thick non-doped Ga_{0.7}In_{0.3}Na_{0.04}As_{0.96} quantum well layer and a 10 nm-thick non-doped GaAs layer were formed. Thereafter, a non-doped GaAs upper barrier layer 1410 was formed. Further, p type AlGaAs/GaAs (p type impurity concentration=1×10¹⁸ cm⁻³) was deposited five times to form upper selective oxidation layers 1405 and 1406. To adjust the angle θ of the aperture with respect to a direction perpendicular to the substrate in the selective oxidation layers to 60°, the content of Ga in the five AlGaAs layers was changed every 4.8 μm of the oxidation distance from 24 μm to 4.8 μm. Finally, a p type GaAs contact layer (p type impurity concentration=1×10¹⁹ cm⁻³) 1407 was formed to complete the crystal growth step. Subsequently, the process step for the manufacture of a laser structure was made on the complete multi-layer grown wafer. After the wafer was patterned in a stripe form having a width of 50 μm in the photolithographic step, mesa etching was carried out up to the active region 1404 using this patterned mask. A mixed solution of ethylene glycol, hydrogen peroxide (H₂O₂) and phosphoric acid (H₃PO₄) was used as an etchant. Selective oxidation was then made on the formed mesa structure to form an aperture. In a steam atmosphere, the wafer was heated at 400° C. to change the side portions of the selective oxidation layers to AlxOy insulating layers. Thereby, selective oxidation layers having an aperture which became wider stepwise as shown in FIG. 14 were formed in the upper cladding layer. Thereafter, SiO₂1409 was deposited on the entire surface of the wafer and part of SiO₂ was removed by etching in the photolithographic step to form a p-side upper contact 1408 and an n-side lower contact 1401 so as to complete a laser. The thus manufactured end surface-emitting laser continuously oscillated at an oscillation wavelength of 1.3 μm and a threshold current of 10 mA at room temperature. Thus, the laser showed excellent modulation characteristics.

<Comparison with the Prior Art>

It has been described that an AlAs/GaAs-based semiconductor multi-layer film is mainly used as the upper and lower DBR's of a surface-emitting laser. In general, a current is injected into the active region from the upper contact through the p type upper DBR. At this point, the difference of energy at the hetero interface of the AlAs/GaAs-based semiconductor becomes a large resistance component for electron holes having large effective mass and increases R. That is, it can be said that the resistance component of a laser is controlled by the p type DBR. To cope with this, attempts have been made to introduce an AlGaAs semiconductor layer whose composition is changed gradually into the AlAs/GaAs hetero interface and to carry out p type doping only on the AlAs side in order to reduce the resistance component of the hetero interface. However, since R of the p type AlAs/GaAs-based semiconductor DBR is substantially high, it is considered that 50 Ω is the lower limit of R. Therefore, to obtain a surface-emitting laser having a transmission rate higher than 50 Gb/s, C must be reduced up to 50 fF.

C and R in the structure of a general surface-emitting laser shown in FIG. 2 are first taken into consideration. C is determined by the active region 204 and the AlxOy insulating layer 205 which are generally not doped. Since the thicknesses of these portions are only 0.5 to 1 μm, C becomes extremely large. Meanwhile, assuming that R is controlled only by the upper p type DBR as described above, it is determined by the upper DBR 207 and the aperture 206 of the current confinement layer. The upper DBR 207 has a large thickness l and a large area S2. Since the aperture 206 of the current confinement layer has a small area S2 and a small thickness l, the introduction of the current confinement layer does not have a large influence upon the increase of R. As a result, as C is extremely large, f3 dB which is in proportion to a reciprocal of the CR product is calculated to be 30 Gb/s which is smaller than the targeted value of 50 Gb/s (R is 50 Ω and C is 100 fF as the optimal values in the current surface-emitting laser). Therefore, to attain 50 Gb/s as f3 dB of a laser, f3 dB must be improved to about 1.5 times or more the current value. The CR product must be reduced to 65% or less of the current value.

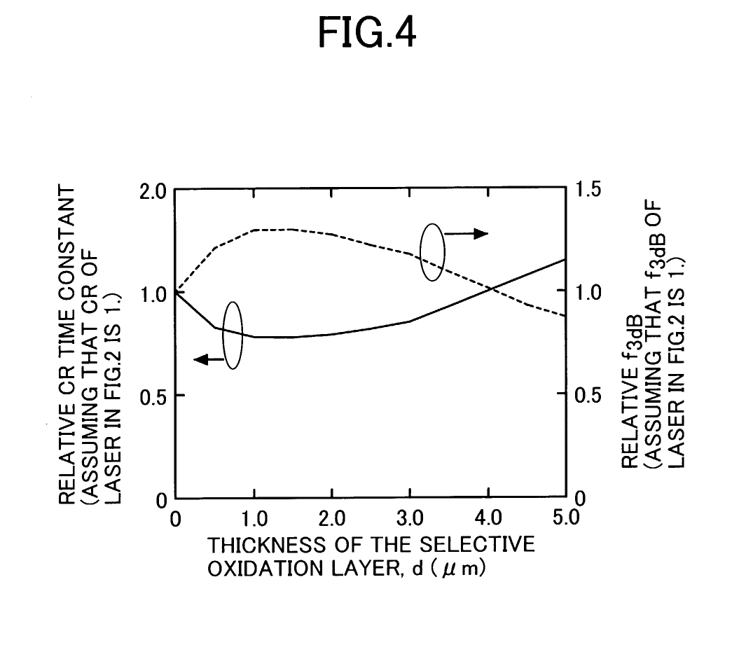

The structure shown in FIG. 3 will be then examined. As shown in FIG. 3, changes in the CR product and f3 dB of the laser structure comprising the insulating part 307 of the capacitance reducing layer having a thickness d from the current confinement layer were obtained. The mesa of the surface-emitting laser is circular and has a diameter of 20 μm and the diameter of the current confinement layer is 5 μm. The thickness of the upper p type DBR is 5 μm and the thickness of the active region is 0.5 μm. FIG. 4 shows the results. The size of the aperture 306 of the capacitance reducing layer was changed to a range from 5 μm which is the same as the current confinement layer to 20 μm which is the diameter of the mesa. The most excellent value was plotted in FIG. 4. Relative values are given when the value of a general surface-emitting laser structure shown in FIG. 2 is 1. As understood from FIG. 4, the smallest value is obtained when d is about 1.5 μm but f3 dB is improved to 1.3 times that of the laser shown in FIG. 2, which is smaller than the target value. In the structure of FIG. 3, the value C is almost half the current value. Meanwhile, R is 1.5 to 2 times larger than the current value because of the trade-off relationship, whereby a not so large effect is obtained in terms of the CR product. Consequently, it is difficult to achieve the target value only by using the technology of the prior art.

According to the present invention, there can be provided a semiconductor laser device capable of high-speed operation. The present invention makes it possible to attain high-speed operation higher than 50 Gb/s. According to the present invention, there can be provided an optical module comprising a surface-emitting laser device capable of higher-speed operation.

The foregoing invention has been described in terms of preferred embodiments. However, those skilled, in the art will recognize that many variations of such embodiments exist. Such variations are intended to be within the scope of the present invention and the appended claims.

What is claimed is:

1. A surface-emitting laser which comprises
an active region,
first and second DBR's sandwiching this active region from above and below with surfaces parallel to the main surface of the active region to form optical resonators,
a first contact formed on at least one of the first and second DBR's, and
a second contact on the opposite side to the first contact with the above resonators interposed therebetween on a semiconductor substrate; and
which further comprises a plurality of layers forming
a first lamellar region having an insulating region in its peripheral portion on a surface parallel to the main surface of the active region and close to the active region and
a second lamellar region having an insulating region in its peripheral portion on a surface farther from the active region than the first lamellar region in the inside of at least one of the first and second DBR's,
wherein the width of the insulating region in the peripheral portion of the second lamellar region of the plurality of layers being smaller than the width of the insulating region in the peripheral portion of the first lamellar region.

2. The surface-emitting laser according to claim 1, wherein the DBR is a multi-layer DBR's having semiconductor layers and the insulating regions in the peripheral portions of the first and second lamellar regions existent in the inside of the DBR are formed by selectively oxidizing the semiconductor layers of the multi-layer DBR.

3. The surface-emitting laser according to claim 2, wherein the insulating regions in the peripheral portions of the first and second lamellar regions existent in the inside of the DBR are formed by selectively oxidizing the semiconductor layers of the multi-layer DBR and the width of the insulating region in the peripheral portion of the second lamellar region decreases as it becomes farther from the active region.

4. A surface-emitting laser which comprises
an active region,
upper and lower DBR's sandwiching the active region from above and below to form resonators,
a first contact on at least one of the upper and lower DBR's and
a second contact on the opposite side to the first contact with the resonators interposed therebetween on a semiconductor substrate; and
which further comprises a plurality of selective oxidation layers having an unoxidized region in the upper DBR, the lower DBR or both of them, the unoxidized regions becoming wider stepwise as they become farther from the active region.

5. The surface-emitting laser according to claim 4, wherein the selective oxidation layers are formed from the active region close to or up to the end opposite to the active region.

6. The surface-emitting laser according to claim 4, wherein the selective oxidation layers include at least one compound semiconductor layer which contains 90% or more of Al as a group III atom.

7. The surface-emitting laser according to claim 5, wherein the selective oxidation layers include at least one compound semiconductor layer which contains 90% or more of Al as a group III atom.

8. An end surface-emitting laser which comprises
an active region,
first and second cladding layer regions sandwiching this active region from above and below with surfaces parallel to the main surface of the active region to form optical resonators,
a first contact formed on at least one of the first and second cladding layer regions, and
a second contact on the opposite side to the first contact with the above resonators interposed therebetween on a semiconductor substrate; and
which comprises a plurality of layers forming a first lamellar region having an insulating region in its peripheral portion on a surface parallel to the main surface of the active region and close to the active region and a second lamellar region having an insulating region in its peripheral portion on a surface farther from the active region than the first lamellar region in the inside of at least one of the first and second cladding layer regions,
wherein the width of the insulating region in the peripheral portion of the second lamellar region of the plurality of layers being smaller than the width of the insulating region in the peripheral portion of the first lamellar region.

9. The end surface-emitting laser according to claim 8, wherein the cladding layer regions have a semiconductor multi-layer film and the insulating regions in the peripheral portions of the first and second lamellar regions existent in the inside of the cladding layer regions are formed by selectively oxidizing the semiconductor layers of the semiconductor multi-layer film.

10. The end surface-emitting laser according to claim 8, wherein the insulating regions in the peripheral portions of the first and second lamellar regions existent in the inside of the cladding layer regions are formed by selectively oxidizing the semiconductor layers of the semiconductor multi-layer film and the width of the insulating region in the peripheral portion of the second lamellar region decreases as it becomes farther from the active region.

11. An end surface-emitting laser which comprises
an active region,
upper and lower cladding layer regions sandwiching the active region from above and below to form resonators,
a first contact on at least one of the upper and lower cladding layer regions, and
a second contact on the opposite side to the first contact with the resonators interposed therebetween on a semiconductor substrate; and
which further comprises
a plurality of selective oxidation layers having an unoxidized region in the upper cladding layer region, lower cladding layer region or both of them,
wherein the unoxidized regions becoming wider stepwise as they become farther from the active region.

12. The end surface-emitting laser according to claim 11, wherein the selective oxidation layers are formed from the active region close to or up to the end opposite to the active region.

13. The end surface-emitting laser according to claim 12, wherein the selective oxidation layers include at least one compound semiconductor film which contains 90% or more of Al as a group III atom.
